(19) United States
(12) Patent Application Publication
(10) Pub. No.: US 2003/0167936 A1
(43) Pub. Date: Sep. 11, 2003

(54) Controller for a hydraulic press and method for the operation thereof

(76) Inventors: Matthias Hahn, Saarburg (DE); Arno Mohn, Trier (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/380,887

(22) PCT Filed: Aug. 24, 2001
(86) PCT No.: PCT/IB01/01527

(30) Foreign Application Priority Data
Sep. 20, 2000 (CH) 1826/00

(51) Int. Cl. B30B 15/14; B30B 15/16

(52) U.S. Cl. 100/48

(57) ABSTRACT

The invention relates to a controller for a hydraulic press, comprising a pressing cylinder (1), a reservoir (2), a valve group (3), a pressure medium reservoir (7) and a hydraulic pump (6), connected together by means of a cylinder line (4), a reservoir line (5) and a tank line (8). According to the invention, a pressure converter (9) is arranged on the valve group (3), which may operate as a pressure amplifier or pressure reducer. The particular mode of action of said controller is achieved whereby the valve group (3) comprises a pre-press valve (11), a low-pressure chamber outlet valve (12), a low-pressure chamber inlet valve (13), a main press valve (14), a closing valve (15), a pressure release valve (16) and a 3-way valve (17), which may be operated by a particular control sequence. Said invention is applicable in hydraulic presses and of particular advantage in presses for the forming of ceramic pieces such as tiles.

The invention relates to a hydraulic press of the type mentioned in the preamble of claim 1, to a method for the operation thereof according to the preamble of claim 8 and to a use according to claim 11.

Such hydraulic presses are used when workpieces are to be formed or reformed. Hydraulic presses are also used for cutting operations. The required force of the hydraulic press depends on the workpiece. In the ceramic industry, presses having a pressing force of 20 000 kN or more are used. In this case, with a view to efficient manufacture, the cycle time for a pressing operation should be as short as possible. Cycle sequences of 20 strokes per minute are a guideline. The pressing force and the cycle time determine the energy to be expended, that is to say, in hydraulic presses, the power of pumps and of electric motors driving these pumps. In hydraulic presses according to the prior art, accumulators are also used, such as pressure medium accumulators or flywheels.

A hydraulic press of the type mentioned in the preamble of claim 1 is known from DE-A1-43 20 213. Here, in the feed circuit of the hydraulic pressing cylinder, there is a pressure medium accumulator which is charged during the return stroke of the press and is utilized for the drive during the feed of the pressing die. Energy can thus be saved in the main drive.

JP-A-63 256 300 discloses a press which is operated with a multistage pressure converter. After a first pressing operation at low pressure, the hydraulic oil is discharged into the tank. A second pressing operation then takes place at high pressure. Energy recovery is consequently not possible in this case.

A hydraulic drive system for a press is known from U.S. Pat. No. 5,852,933 and DE-A1-44 36 666. It contains a low-pressure and a high-pressure circuit. In this, there are three hydrostatic machines, two of which are coupled mechanically. In order to make satisfactory operation possible, these machines must be adjustable in terms of their absorption volume or delivery volume, this entailing considerable costs. The system described here can be employed only when the press has differential cylinders or synchronous cylinders.

It is also known (DE-A1-43 08 344) to employ the principle of secondary regulation for regulating the drive of a hydraulic press. The various movements of the press ram are combined with one another in such a way that the pressure network operates in a closed circuit, the maximum system pressure being determined by the pressure medium accumulator.

According to DE-A1-43 08 344, the fact that the hydraulic oil is definitely compressible also plays a part in the regulation of a hydraulic press. This has an effect in a press cycle during both compression and decompression and constitutes a source of losses. The prior art has continued largely to ignore the fact that the mechanical parts of the press also absorb energy due to the elastic deformation of their components. This energy has to be expended during the closing operation of the press. This energy is not recovered during the opening operation.

The object on which the invention is based is to provide a hydraulic press, the hydraulic control of which is set up in such a way that, in total, the energy requirement is reduced, without an increased outlay in terms of apparatus being necessary at the same time. The control is in this case also to be capable of being used in a press with plunger cylinders.

Said object is achieved, according to the invention, by means of the features of claims 1 and 7. Advantageous developments may be gathered from the dependent claims.

An exemplary embodiment of the invention is explained in more detail below with reference to the drawing in which:

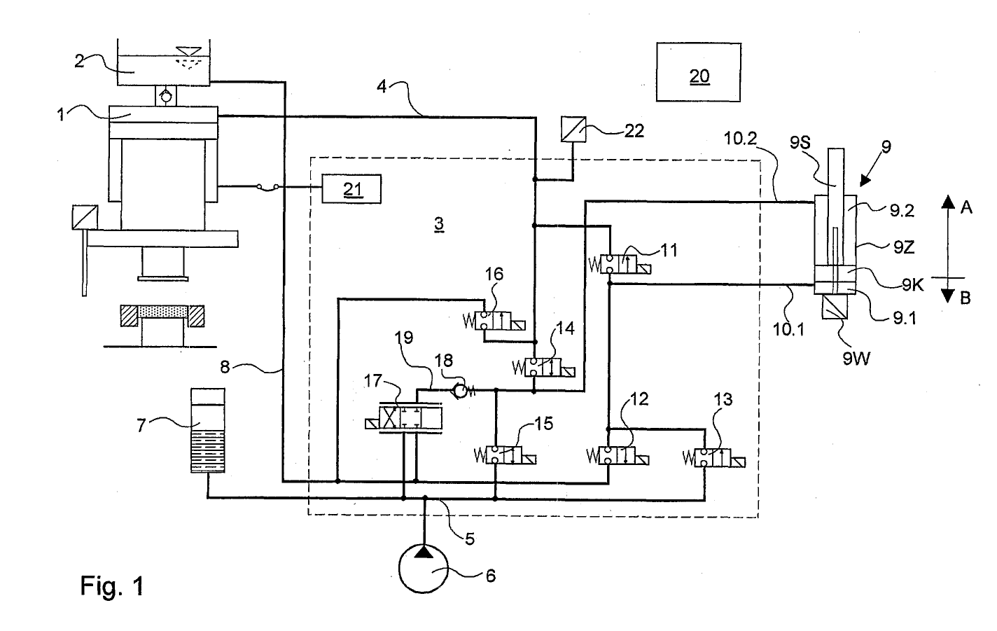

FIG. 1 shows a hydraulic diagram of a press control,

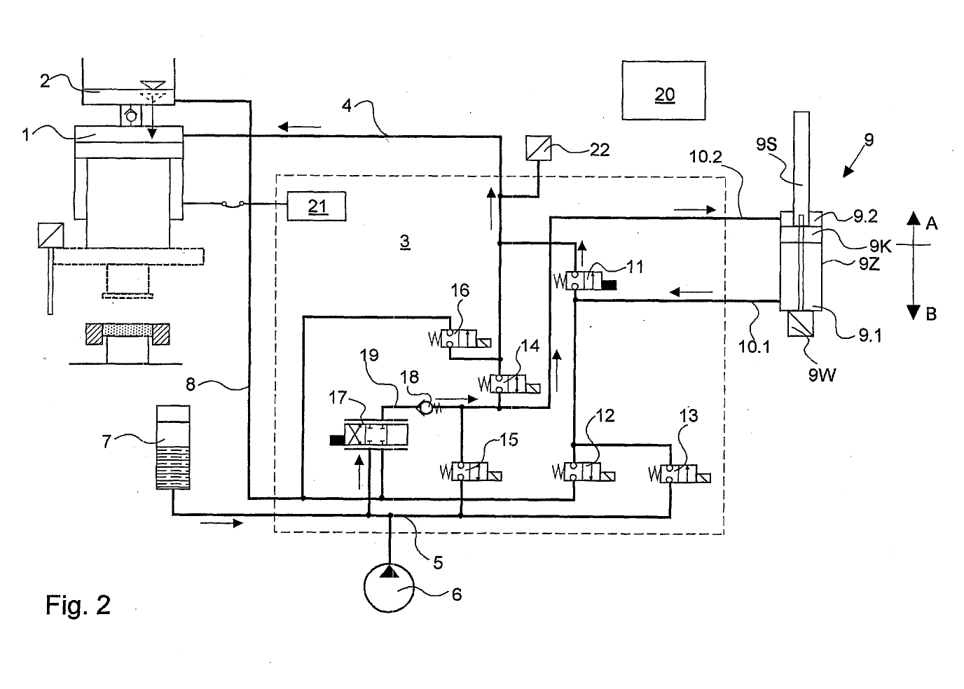

FIGS. 2 to 6 show this diagram with an illustration of individual steps within a cycle, and

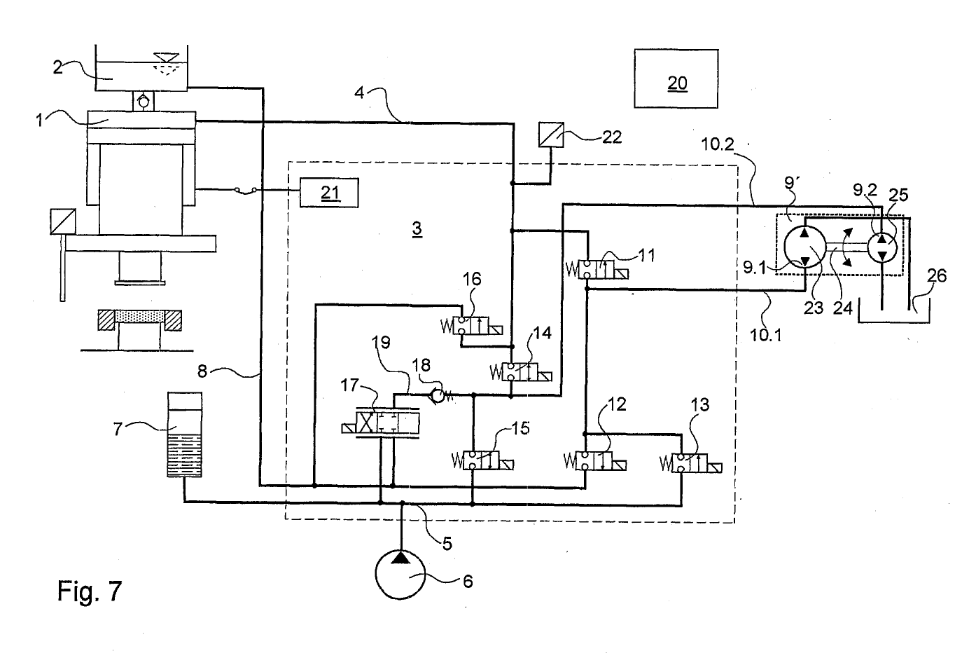

FIG. 7 shows a diagram of a design variant of the press control.

In FIG. 1, 1 denotes a press cylinder which is assigned a reservoir 2 for the hydraulic medium. The reference numeral 3 designates a valve group which contains a series of valves referred to hereafter. The hydraulic medium is conveyed between the press cylinder 1 and the valve group 3 via a cylinder line 4.

An accumulator line 5 is connected to the valve group 3. A hydraulic pump 6 delivers hydraulic medium into this accumulator line 5 and is driven by an electric motor which, however, is not illustrated here. A pressure medium accumulator 7 is connected to the accumulator line 5 which also runs within the valve group 3. That is to say, also, the hydraulic pump 6 is capable of delivering the hydraulic medium into the pressure medium accumulator 7. A nonreturn valve, not illustrated, may be arranged in the line segment between the hydraulic pump 6 and the accumulator line 5, in order to relieve the hydraulic pump 6 of the pressure prevailing in the pressure medium accumulator 7, when the hydraulic pump 6 is not running.

A tank line 8 leads from the valve group 3 to the reservoir 2. According to the invention, moreover, the valve group 3 has connected to it a pressure converter 9 which, according to the general idea of the invention, can act, on the one hand, as a pressure intensifier and, on the other hand, as a pressure reducer. For this purpose, the pressure converter 9 has a piston 9K which is displaceable within a cylinder 9Z and which separates from one another a low pressure space 9.1 having a large effective cross section from a high-pressure space 9.2 having a small effective cross section. In order to obtain the smaller effective cross section, a piston rod 9S connected to the piston 9K is located in the high-pressure space 9.2. The effective ratio in terms of pressure and volume flow is determined by the cross sections of the two pressure spaces 9.1 and 9.2. The cross section is determined, for the low-pressure space 9.1, by the inside diameter of the cylinder 9Z according to

A_{9.1}=¼*d_{9Z}²*π

and, for the high-pressure space 9.2, by the difference between the inside diameters of the cylinder 9Z and of the piston rod 9S according to

A_{9.2}=¼*(d_{9Z}−d_{9S})²*π

A_{9.1} is in this case the hydraulically effective cross section of the low-pressure space 9.1, A_{9.2} is that of the high-pressure space 9.2, d_{9Z} is the inside diameter of the cylinder 9Z and d_{9S} is the diameter of the piston rod 9S.

The pressure ratio of the pressure converter 9 and, correspondingly, also the ratio of the volume flows is therefore determined by A_{9.1}:A_{9.2}. The ratio A_{9.1}:A_{9.2} is, for example, 2:1. The position of the piston 9K is detected by means of a displacement transducer 9W.

The low-pressure space 9.1 is connected to a pressure converter low-pressure line 10.1 of the valve group 3. Located on this pressure converter low-pressure line 10.1 are three switching valves, to be precise a prepressing valve 11, the second connection of which is connected to the cylinder line 4, a low-pressure chamber outlet valve 12, the second connection of which is connected to the reservoir 2 via the tank line 8, and a low-pressure chamber inlet valve 13, the second connection of which is connected to the accumulator line 5 and consequently also to the pressure medium accumulator 7.

The high-pressure space 9.2 is connected to a pressure converter high-pressure line 10.2 of the valve group 3. Valves are likewise located on this pressure converter high-pressure line 10.2, to be precise a main pressing valve 14, the second connection of which is connected to the cylinder line 4, and a stop valve 15, the second connection of which is connected to the accumulator line 5 and consequently also to the pressure medium accumulator 7. A pressure relief valve 16 lies between the cylinder line 4 and the tank line 8. Moreover, a third valve, to be precise a 3-way valve 17, with a preceding nonreturn valve 18, is connected to the pressure converter high-pressure line 10.2, the 3-way valve 17 being connected, on the other hand, to the accumulator line 5 and consequently also to the pressure medium accumulator 7 and, with its further connection, to the tank line 8 and therefore to the reservoir 2. The line segment between the nonreturn valve 18 and the 3-way valve 17 is designated as a pressing line and is given the reference numeral 19. The nonreturn valve 18 is, in functional terms, a backflow stop valve. The functioning of the various valves 11, 12, 13, 14, 15, 16 and 17 is described in detail hereafter with reference to FIGS. 2 to 6. The valves can be activated electrically and are controlled by a control apparatus 20. The connecting lines, obviously present., from the control apparatus 20 to the valves 11, 12, 13, 14, 15, 16 and 17 are not depicted in the figures for the sake of clarity.

The hydraulic diagram illustrates only the elements essential to the invention, there also being, in addition, a press safety lowering and pullback control 21 which is necessary for the reliable operation of the press cylinder 1 but is irrelevant in terms of the invention. A pressure transducer 22 which detects the pressure in the cylinder line 4 is also necessary.

The electric connections between the control apparatus 20, displacement transducer 9W, pressure transducer 22, press safety lowering and pullback control 21 and further safety-relevant elements on the press are also not illustrated for the sake of clarity.

A first phase of the press operation, to be precise the buildup of the admission pressure, is described below with reference to FIG. 2. The press cylinder 1 is filled in the usual way with hydraulic medium from the reservoir 2, this being indicated by an arrow. As a result, the upper pressing die is lowered and consequently the mold is closed. The piston 9K is at the same time located in an upper position in the vicinity of its upper end position A.

The 3-way valve 17 is then activated in such a way that it releases the throughflow from the connection of the accumulator line 5 to the connection of the pressing line 19. The activation of the 3-way valve 17 is marked in FIG. 2 by its electrically operated drive being filled in in black. By virtue of this opening of the 3-way valve 17, hydraulic medium can then flow from the pressure medium accumulator 7 via said 3-way valve 17 through the pressing line 19, through the nonreturn valve 18 which necessarily opens on account of the pressure of the hydraulic medium, and through the pressure converter high-pressure line 10.2 into the high-pressure space 9.2 of the pressure converter 9, this being indicated in FIG. 2 by arrows. At the same time, the prepressing valve 11 is also activated, this, again, being marked by its electrically operated drive being filled in in black. Consequently, then, hydraulic medium can flow out of the low-pressure space 9.1 via the pressure converter low-pressure line 10.1 through the prepressing valve 11 and the cylinder line 4 into the press cylinder 1. Owing to the area ratio A_{9.2} to A_{9.1}, the pressure converter 9 then acts as a pressure reducer, the quantity of hydraulic medium being increased according to the area ratio A_{9.2} to A_{9.1}. When the area ratio A_{9.2} to A_{9.1} amounts, for example, to 1:2, the pressure is reduced in the ratio of 1:2 by means of the pressure converter 9, but the quantity of hydraulic medium is increased in the ratio of 1:2. Due to the flow of the hydraulic medium, the piston 9K is moved in the direction B.

It should also be noted that the 3-way valve 17 is a proportionally controllable valve, that is to say the drive of the 3-way valve 17 is, for example, a proportional magnet, so that the pressure in the pressing line 9 and in the pressure converter high-pressure line 10.2 and therefore also the pressure in the pressure converter low-pressure line 10.1, in the cylinder line 4 and in the press cylinder 1 can be controlled or regulated.

When the desired admission pressure is reached, this being detected by the pressure transducer 22, transmitted from the latter to the control apparatus 20 and thus noted by the control apparatus 20, the control apparatus 20 causes the 3-way valve 17 and the prepressing valve 11 to be closed.

Subsequently, then, the pressure relief valve 16 is activated and thus opened. A pressure breakdown thereby takes place in the press cylinder 1 and in the cylinder line 4, this being detected by the pressure transducer 22. Hydraulic medium consequently flows from the press cylinder 1 and the cylinder line 4 via the pressure relief valve 16 and through the tank line 8 to the reservoir 2. When the pressure transducer 22 ascertains that the press cylinder 1 and the cylinder line 4 are pressureless, the pressure relief valve 16 is closed again.

It may be advantageous to add a further phase in the buildup of an admission pressure. This is carried out in the way described above, but in this case with a higher admission pressure which is reached by means of an appropriately modified activation of the 3-way valve 17. This phase may take place while the upper die, not illustrated, lies on the workpiece, likewise not illustrated. It may also be advantageous, however, to raise the upper die slightly.

After the phase for building up the admission pressure or admission pressures, the piston 9K is located, within the cylinder 9Z, in a position near the lower end position B, this being determined by the displacement transducer 9W. This position is necessary so that the ma in pressing pressure required can subsequently be generated.

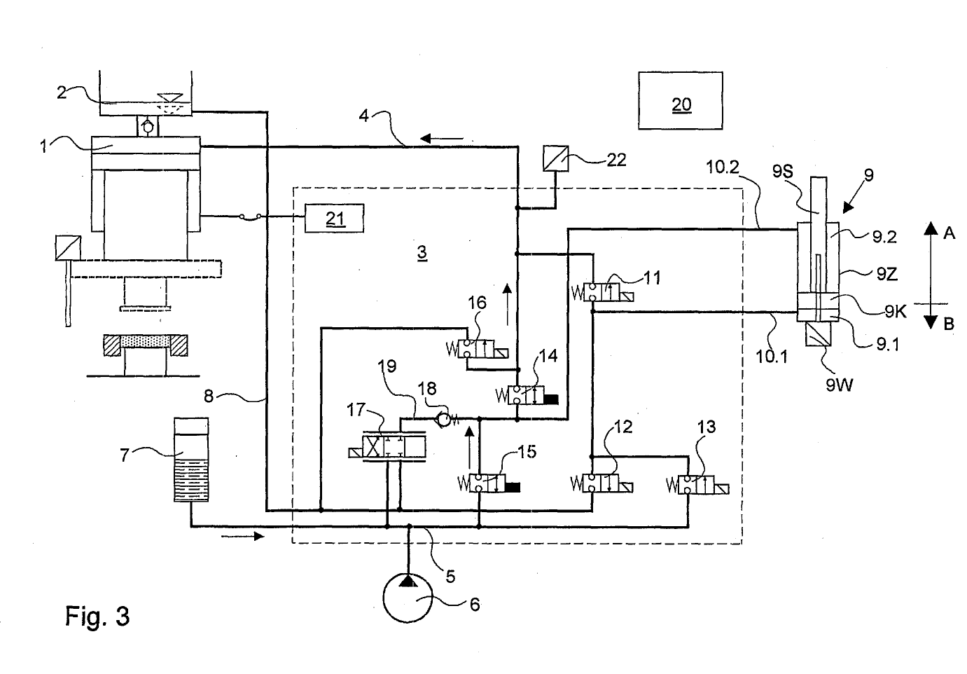

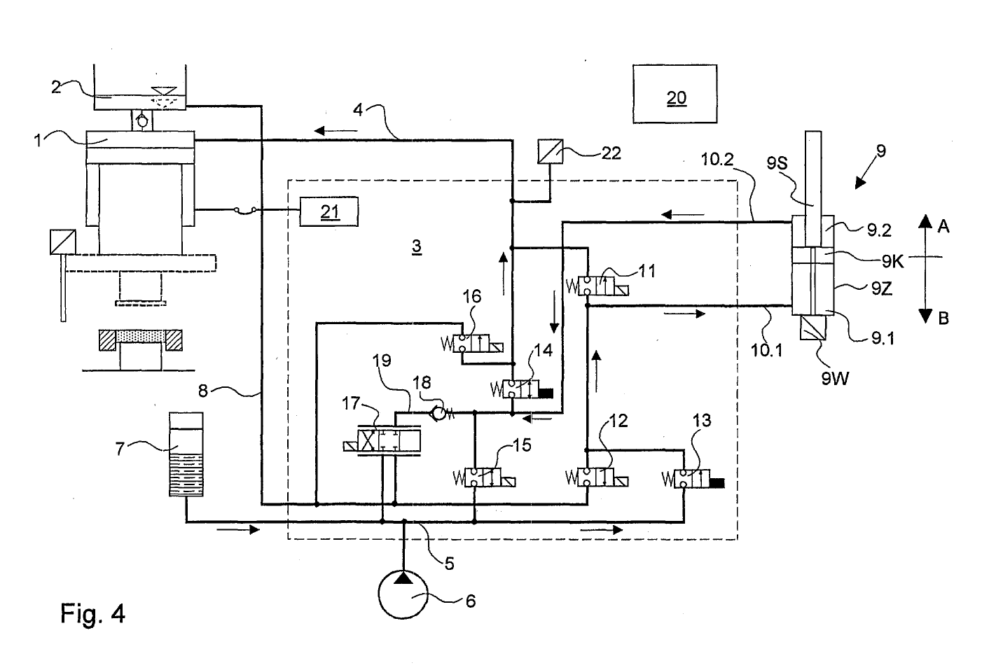

The next phase of press operation, the buildup of the main pressing pressure, then follows. This is described below with reference to FIGS. 3 and 4. FIG. 3 shows the first step of this phase. This figure, then, again illustrates the activated valves by means of a black marking of the electric drives, and the flow of the hydraulic medium is indicated by arrows next to the lines. As can be seen from FIG. 3, therefore, in this case the stop valve 15 and the main pressing valve 14 are activated. The stop valve 15 and the main pressing valve 14 are then opened. These two valves 14, 15 are advantageously electrically activatable OPEN/SHUT valves. The prepressing valve 11, low-pressure chamber inlet valve 13, low-pressure chamber outlet valve 12 and pressure relief valve 16 are advantageously also of this type.

By the stop valve 15 and main pressing valve 14 being activated, the flow of hydraulic medium becomes possible from the pressure medium accumulator 7 via the accumulator line 5, through the stop valve 15 and the main pressing valve 14 and through the cylinder line 4 to the press cylinder 1. Thus, in the press cylinder 1, a pressure is built up which is preselectable, but corresponds at most to the pressure in the pressure medium accumulator 7.

FIG. 4 shows the second step of the phase of building up the main pressing pressure. In this case, the low-pressure chamber inlet valve 13 and the main pressing valve 14 are activated, that is to say open, as is marked, in the same way as in the previous figures, by the electric drives of the valves 13, 14 being illustrated in black. The flow of hydraulic medium which is established is again identified by arrows next to the lines. Hydraulic medium therefore then flows from the pressure medium accumulator 7 through the accumulator line 5 and the open low-pressure chamber inlet valve 13 and through the pressure converter low-pressure line 10.1 into the low-pressure space 9.1 of the pressure converter 9. The pressure prevailing in the pressure medium accumulator 7 also thereby arises in the low-pressure space 9.1. As a result of the area ratio A_{9.2} to A_{9.1}, a higher pressure simultaneously arises in the high-pressure space 9.2, said pressure therefore being twice as high as the pressure in the pressure medium accumulator 7 in the case of an already mentioned area ratio A_{9.2} to A_{9.1} of 1:2. Since, however, the main pressing valve 14 is now also open, a likewise high pressure is built up in the press cylinder 1. At the conclusion of this phase of press operation, therefore, the pressure in the press cylinder 1 is twice as high as the pressure in the pressure medium accumulator 7 under the given conditions.

The buildup of this pressure in the press cylinder 1 is tracked by the pressure transducer 2. As soon as the desired pressure is reached, the low-pressure chamber inlet valve 13 and the main pressing valve 14 are closed again. It goes without saying that this pressure buildup is associated with a flow of hydraulic medium from the pressure medium accumulator 7 into the low-pressure space 9.1 and from the high-pressure space 9.2 via the cylinder line 4 to the press cylinder 1, with the result that the piston 9K is also displaced in the direction A. Owing to the are a ratio A_{9.2} to A_{9.1}, the quantity of hydraulic medium flowing out from the high-pressure space 9.2 is in this case, under the given conditions of an area ratio A_{9.2} to A_{9.1} of 1:2, only half as large as the quantity of hydraulic medium which flows from the pressure medium accumulator 7 into the low-pressure space 9.1.

The press then reaches its maximum pressure and performs the pressing. Under the effect of this pressure, the stresses in the components of the press are also at the maximum values. Since the components are deformed elastically, energy is therefore stored in these components. A further energy potential is the compressible hydraulic medium volume in the press cylinder 1, press line 4, pressure converter high-pressure line 10.2 and high-pressure space 9.2 of the pressure converter 9.

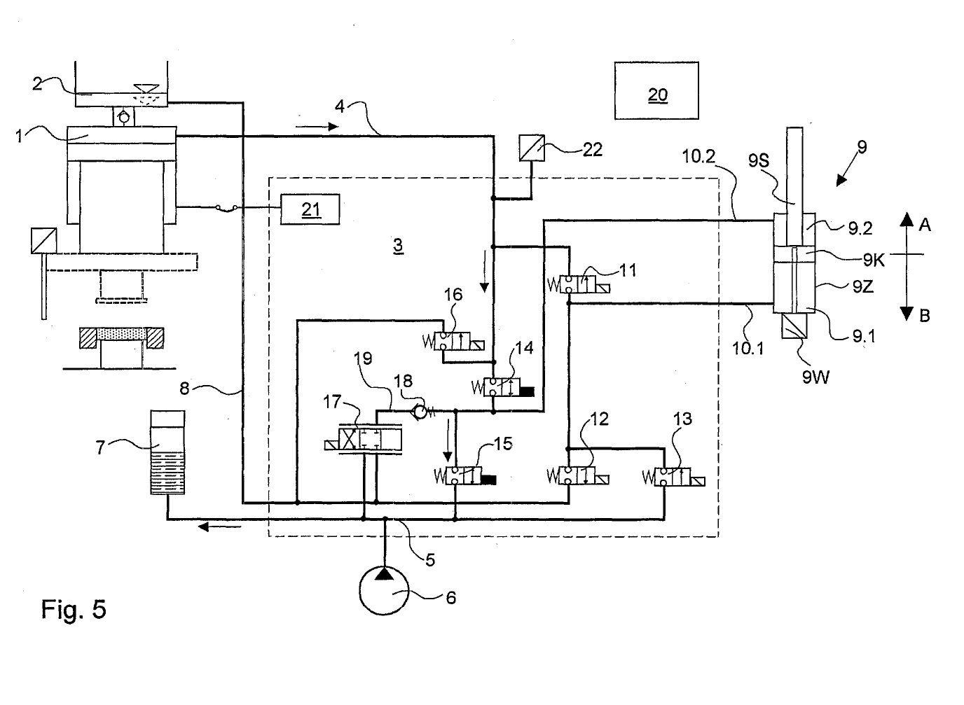

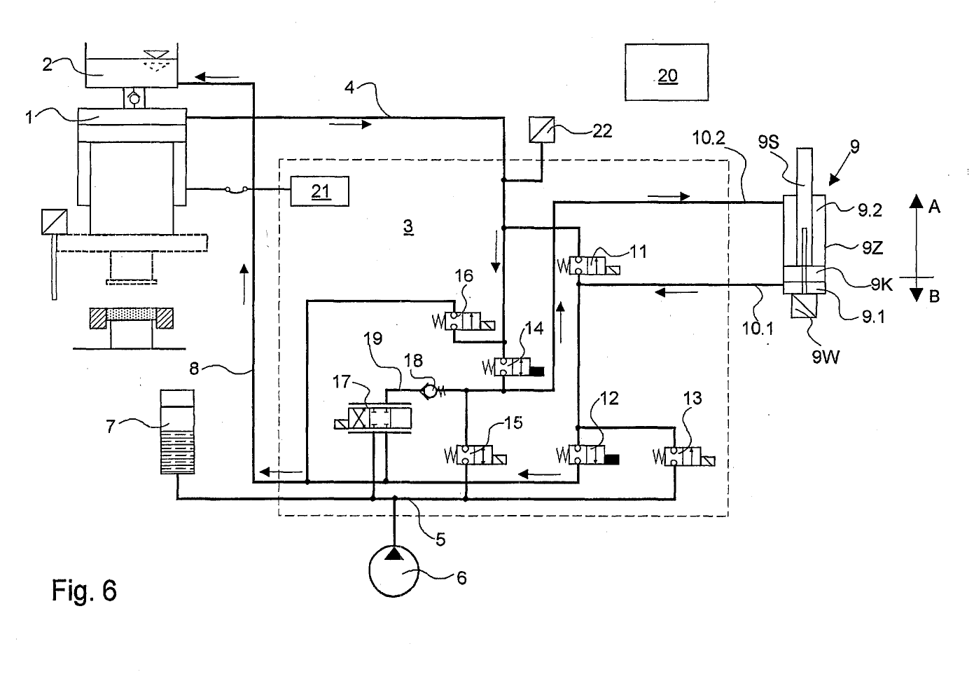

A phase of relief with stress breakdown and decompression then subsequently takes place. This phase occurs in three steps, the first two of which are illustrated in FIGS. 5 and 6. The first step is shown in FIG. 5. The main pressing valve 14 and the stop valve 15 are then open, this being illustrated by a black marking of the drives of the valves 14, 15 in a similar way to the previous figures. The hydraulic medium can then flow from the press cylinder 1 to the pressure medium accumulator 7, at the same time following the path through the cylinder line 4, the main pressing valve 14, the stop valve 15 and accumulator line 5. The flow occurs due to the fact that, as mentioned above, the pressure in the press cylinder 1 is higher than it is in the pressure medium accumulator 7. The first step lasts until the pressures in the press cylinder 1 and in the pressure medium accumulator 7 are equal. That is to say, however, also that a considerable part of the energy stored in the components of the press is recovered, in that the pressure in the pressure medium accumulator 7 is increased. This is a decisive advantage of the controller according to the invention and of the method for the operation thereof.

The second step of the relief phase is described with reference to FIG. 6, again the drives of the activated valves being illustrated by being filled in in black, and the flow of hydraulic medium being identified by arrows at the lines. This second step serves for preparing the next press cycle. For this, the pressure converter 9 has to assume a defined position in the direction of the end position B. The volume still remaining in the low-pressure space 9.1 of the pressure converter is then such that the admission pressures for the next work cycle can be provided by means of this volume. A check as to whether this is so can be made by means of the displacement transducer 9W. If this is not so, the residual pressure prevailing in the press cylinder 1, in the cylinder line 4 and in the pressure converter high-pressure line 10.2 is utilized, by the opening of the main pressing valve 14 and the low-pressure chamber outlet valve 12, in order to bring the piston 9K of the pressure converter 9 into the desired position. This desired position is illustrated in FIG. 6. In this case, the high-pressure space 9.2 is also already filled again with pressurized hydraulic medium, so that no hydraulic medium at all has to be extracted from the pressure accumulator 7 for filling purposes. This signifies a further energy saving. The hydraulic medium displaced out of the low-pressure space 9.1 during the movement of the piston 9K passes via the low-pressure chamber outlet valve 12 through the tank line 8 into the reservoir 2. When the piston 9K has reached the desired position, this being determined, as stated, by the displacement transducer 9W, the low-pressure chamber outlet valve 12 and the main pressing valve 14 are closed again.

Subsequently, in the third step, the residual pressure in the press cylinder 1 and in the cylinder line 4 is also broken down completely, this being carried out by means of the opening of the pressure relief valve 16. In this case, under the effect of the residual pressure, hydraulic medium flows from the press cylinder 1 through the cylinder line 4, the pressure relief valve 16 and the tank line 8 into the reservoir 2. The flow ceases as soon as the residual pressure in the press cylinder 1 is broken down completely. The pressure relief valve 16 is then closed again.

At the same time, however, the pressure in the high-pressure space 9.2 and in the pressure converter high-pressure line 10.2 is maintained. This pressure can be utilized during the next press cycle, thus resulting, in turn, in an energy saving, since the pressure does not have to be built up anew.

FIG. 7 shows a variant of the press control according to the invention. As compared with the example of FIG. 1, the only change is that the pressure converter 9′ is of a different type from the pressure converter 9 according to FIGS. 1 to 6. The pressure converter 9′ comprises essentially a first pump 23, the shaft 24 of which is coupled rigidly to a second pump 25, so that the shaft 24 is common to both pumps 23, 25. The first pump 23 is connected, on the one hand, to the pressure converter low-pressure line 10.1, this side of the pump 23 acting as a low-pressure space 9.1, and, on the other hand, to a tank 26. The second pump 25 is connected, on the one hand, to the pressure converter high-pressure line 10.2, this side of the pump 25 acting as a high-pressure space 9.2, and, on the other hand, likewise to the tank 26. The two pumps 23, 25 are not driven by a motor, but, by virtue of the rigid connection, act in each case as a unit consisting of pump and of hydraulic motor. This combination of the two pumps 23, 25 takes effect as a pressure converter in that the specific delivery volume, that is to say the volume per revolution, is different, this being illustrated in FIG. 7 symbolically by the different size of the pumps 23, 25. Thus, for example, this ratio amounts to 2:1. This also occurs in that the areas effective in the two pumps 23, 25 in the delivery of the hydraulic medium through the latter correspond to the areas A_{9.1} and A_{9.2} according to the first exemplary embodiment. Correspondingly, the pressure converter 9′ behaves in exactly the same way as the pressure converter 9 during the different phases of press operation which are illustrated in FIGS. 2 to 6 and described with reference to these figures. During the above-mentioned first phase of press operation, for example, the pressure converter 9′ acts as a pressure reducer, the second pump 25 operating as a hydraulic motor and driving the first pump 23. In action as a pressure intensifier, the first pump 23 acts as a hydraulic motor which drives the second pump 25. The individual phases and their steps of a press cycle correspond to what was described above.

It is also advantageous, in this case, that a displacement transducer 9W is not required and the pressure converter 9′ does not have to assume a defined position for the preparation of the next press cycle, thus simplifying the control method.

In spite of the very simple construction of the controller according to the invention, energy from individual pressing steps can be recovered by means of this controller. Thus, as described above, even the energy stored elastically in the press, in the workpiece and in the compressible hydraulic oil is recovered. At the same time, the controller manages without costly structural elements, such as adjustable pumps.

It was found by means of tests that, by virtue of the controller according to the invention, a considerable energy saving can be achieved, as compared with the known prior art. The energy saving may definitely amount to around 40%.

The invention may, in principle, be utilized to great advantage in hydraulic presses of various types for various fields of use. The press may in this case be equipped with differential cylinders, synchronous cylinders or else plunger cylinders. It is particularly advantageous if the controller according to the invention is used in presses for the shaping of ceramic parts, such as tiles.

It may be gathered from the above-described construction and from the mode of action described at the same time that both the construction of the controller and the mode of operation, that is to say the control method, are the subject of the invention.

List of reference symbols

| | |
|---|---|
| 1 | Press cylinder |
| 2 | Reservoir |
| 3 | Valve group |
| 4 | Cylinder line |
| 5 | Accumulator line |
| 6 | Hydraulic pump |
| 7 | Pressure medium accumulator |
| 8 | Tank line |
| 9 | Pressure converter (first design variant) |
| 9′ | Pressure converter (second design variant) |
| 9.1 | Low-pressure space |
| 9.2 | High-pressure space |
| 9Z | Cylinder |
| 9K | Piston |
| 9S | Piston rod |
| 9W | Displacement transducer |
| 10.1 | Pressure converter low-pressure line |
| 10.2 | Pressure converter high-pressure line |
| 11 | Prepressing valve |
| 12 | Low-pressure chamber outlet valve |
| 13 | Low-pressure chamber inlet valve |
| 14 | Main pressing valve |
| 15 | Stop valve |
| 16 | Pressure relief valve |
| 17 | Three-way valve |
| 18 | Nonreturn valve |
| 19 | Pressing line |
| 20 | Control apparatus |
| 21 | Press safety lowering and pullback control |
| 22 | Pressure transducer |
| 23 | First pump |
| 24 | Shaft |
| 25 | Second pump |
| 26 | Tank |

1. A controller for a hydraulic press with a press cylinder (1), a reservoir (2), a valve group (3), a pressure medium accumulator (7) and a hydraulic pump (6), the press cylinder (1), reservoir (2), valve group (3), pressure medium accumulator (7) and hydraulic pump (6) being connected to one another by means of a cylinder line (4), an accumulator line (5) and a tank line (8), characterized in that the valve group (3) is assigned a pressure converter (9; 9′) which can be operated as a pressure intensifier and as a pressure reducer.

2. The controller as claimed in claim 1, characterized in that the pressure converter (9) consists of a piston (9K) displaceable in a cylinder (9Z) and of a piston rod (9S) connected rigidly to the piston (9K), the pressure converter (9) having a low-pressure space (9.1) and a high-pressure space (9.2) which are separated from one another by the piston (9K), and in that the low-pressure space (9.1) has a larger cross section A_{9.1} than the high-pressure space (9.2) which possesses a cross section A_{9.2}.

3. The controller as claimed in claim 1, characterized in that the pressure converter (9′) consists of a first pump (23) with a higher specific delivery volume and of a second pump (25) with a lower specific delivery volume, which are connected rigidly by means of a shaft (24), one side of the first pump (23) acting as a low-pressure space (9.1) and one side of the second pump (25) acting as a high-pressure space (9.2).

4. The controller as claimed in claim 2 or 3, characterized in that the low-pressure space (9.1) is connected to the valve group (3) via a pressure converter low-pressure line (10.1), and in that this pressure converter low-pressure line (10.1) is connected
to a prepressing valve (11), the second connection of which lies on the cylinder line (4),
to a low-pressure chamber inlet valve (13), the second connection of which lies on the accumulator line (5), and
to a low-pressure chamber outlet valve (12), the second connection of which lies on the tank line (8), and in that the high-pressure space (9.2) is connected to the valve group (3) via a pressure converter high-pressure line (10.2), and in that this pressure converter high-pressure line (10.2) is connected
to a main pressing valve (14), the second connection of which lies on the cylinder line (4),
to a stop valve (15), the second connection of which lies on the accumulator line (5), and
via a nonreturn valve (18) and a pressing line (19) to a 3-way valve (17), the second connection of which lies on the accumulator line (5) and the third connection of which lies on the tank line (8).

5. The controller as claimed in claim 4, characterized in that the 3-way valve (17) is controllable proportionally.

6. The controller as claimed in claim 4 or 5, characterized in that a pressure relief valve (16) is arranged between the cylinder line (4) and the tank line (8).

7. The controller as claimed in claim 6, characterized in that the prepressing valve (11), low-pressure chamber inlet valve (13), low-pressure chamber outlet valve (12), main pressing valve (14), stop valve (15) and pressure relief valve (16) are electrically controllable OPEN/SHUT valves.

8. A method for controlling a hydraulic press with a press cylinder (1), a reservoir (2), a valve group (3), a pressure medium accumulator (7) and a hydraulic pump (6), the press cylinder (1), reservoir (2), valve group (3), pressure medium accumulator (7) and hydraulic pump (6) being connected to one another by means of a cylinder line (4), an accumulator line (5) and a tank line (8), characterized in that a pressure converter (9; 9′) assigned to the valve group (3) can be operated as a pressure intensifier and as a pressure reducer.

9. The method as claimed in claim 8, characterized in that valves arranged in the valve group (3) according to claims 3 and 5 are operated
in that, in a first method step, by the activation of the 3-way valve (17) and of the prepressing valve (11), the pressure converter (9; 9′) acts as a pressure reducer and an admission pressure is built up in the press cylinder (1),
in that, in a further method step, by the activation of the stop valve (15) and of the main pressing valve (14), a pressure in the press cylinder (1) is built up which is preselectable and which corresponds at most to the pressure in the pressure medium accumulator (7),
in that, in a subsequent further method step, by the activation of the main pressing valve (14) and of the low-pressure chamber inlet valve (13), the pressure converter (9; 9′) acts as a pressure intensifier and a pressure in the press cylinder (1) is built up which is higher than the pressure in the pressure medium accumulator (7),
in that, in a subsequent further method step, by the activation of the main pressing valve (14) and of the stop valve (15), the pressure prevailing in the press cylinder (1) is broken down, until it is as high as the pressure in the pressure medium accumulator (7),
in that, if appropriate, in a subsequent further method step, by the activation of the main pressing valve (14) and of the low-pressure chamber outlet valve (12), the piston (9K) of the pressure converter (9) is brought into a position desired for the next press cycle, and
in that, lastly, by the activation of the pressure relief valve (16), the residual pressure in the press cylinder (1) is broken down.

10. The method as claimed in claim 9, characterized in that, at the conclusion of the first method step, this first method step is repeated, a higher admission pressure being built up by means of a modified activation of the 3-way valve.

11. The use of a controller as claimed in claims 1 to 7 and according to the method as claimed in claims 8 to 10 in a press for the shaping of ceramic parts, such as tiles.
